(19) United States
(12) Patent Application Publication
(10) Pub. No.: US 2004/0202177 A1
(43) Pub. Date: Oct. 14, 2004

(54) NHRP/MPOA system and route displaying method

(75) Inventor: Hitoya Tachikawa, Tokyo (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 09/886,870

(22) Filed: Jun. 21, 2001

(30) Foreign Application Priority Data
Jun. 21, 2000 (JP) 186263/2000

(51) Int. Cl. H04L 12/28; H04L 12/56

(52) U.S. Cl. 370/395.1; 370/400

(57) ABSTRACT

A NHRP/MPOA (Next Hop Resolution Protocol/Multi-Protocol Over ATM (Asynchronous Transfer Mode)) system for automatically collecting, by using NHRP Extensions, the IP addresses of MPOA servers via which a Resolution Request is sequentially transferred is disclosed. The system includes an input unit or data inputting means and an output unit implemented by a display or a printer. A route search commanding unit analyzes a command received from the input unit or produces an address from a received packet. A receipt unit receives a Resolution Request from another MPS server or another MPC client. A packet handling unit analyzes the content of a received packet and executes necessary processing. A transmission unit sends a Resolution Request to another MPS server or another MPC client. A memory stores a routing table on a computer (router), network interface information and information relating to a computer (router) on which the MPS is mounted. A route displaying method is also disclosed.

### BACKGROUND OF THE INVENTION

The present invention relates to route display in an NHRP/MPOA (Next Hop Resolution Protocol/Multi-Protocol Over ATM (Asynchronous Transfer Mode)) system. More particularly, the present invention relates to an NHRP/MPOA system capable of automatically collecting, by using NHRP Extensions, the IP (Internet Protocol) addresses of MPOA servers via which a resolution request is sequentially transferred, and a route displaying method.

An NHRP system is defined in RFC (Request for Comments) in “NBMA Next Hop Resolution Protocol (NHRP)”. An MPOA system is a data transfer system using an ATM network prescribed by The ATM Forum and defined in Multi-Protocol over ATM Version 1.0 (AF-MPOA-0087.000).

A problem with a conventional NHRP/MPOA system is that the MPOA system lacks circuitry for finding a route. The NHRP/MPOA system therefore cannot see, before data communication, whether or not address resolution will succeed in the MPOA system. Another problem is that the system cannot see a resolution packet transfer route unless an IP routing table on a router is examined or unless data flowing on a network is collected.

Technologies relating to the present invention are disclosed in, e.g., Japanese Patent Nos. 2,728,064 and 3,000,968.

### SUMMARY OF THE INVENTION

It is an object of the present invention to provide an NHRP/MPOA system capable of automatically collecting, by using NHRP Extensions, the IP addresses of MPOA servers via which a resolution request is sequentially transferred, and a route displaying method.

### BRIEF DESCRIPTION OF THE DRAWINGS

The above and other objects, features and advantages of the present invention will become more apparent from the following detailed description taken with the accompanying drawings in which:

FIG. 1 is a view showing specific interconnected networks for describing the operation of a conventional MPOA system;

FIG. 2 is a block diagram schematically showing an NHRP/MPOA system embodying the present invention;

FIG. 3 is a flowchart demonstrating a specific operation to be executed by the illustrative embodiment on the receipt of a route display command from the user of the system;

FIG. 4 is a flowchart demonstrating a specific operation to be executed by the illustrative embodiment on the receipt of a Resolution Request or a Resolution Reply;

FIG. 5 is a flowchart demonstrating a specific operation to be executed by the illustrative embodiment for displaying a route on the receipt of the Resolution Reply;

FIG. 6 is a schematic block diagram showing an alternative embodiment of the present invention;

FIG. 7 is a flowchart demonstrating a specific operation to be executed by the alternative embodiment on the receipt of a route display command from the user;

FIG. 8 is a flowchart demonstrating a specific operation to be executed by the alternative embodiment on the receipt of an NHRP Error Indication, which is derived from a Resolution Request sent; and

FIG. 9 is a schematic block diagram showing another alternative embodiment of the present invention.

### DESCRIPTION OF THE PREFERRED EMBODIMENTS

To better understand the present invention, a conventional MPOA system will be described first. In a conventional MPOA system, data are transferred via a shortcut VC directly set up on ATM networks without the intermediary of routers. In this type of data transfer system, different networks are connected together at interconnection points. The interconnection points are connected together via routers each transferring data from one network to another network. The individual network has a hierarchical structure including a physical level or layer 2 and a logical level or layer 3. For data transfer, layer-by-layer addresses are used that can be unconditionally distinguished.

More specifically, the data transferring method described above transfers data by adding the address of a source terminal and that of a destination terminal to the data. Such addresses are unconditionally determined layer by layer beforehand. A source terminal for sending data and a router each determine a respective destination by joining the layer-by-layer addresses. Further, the router determines a destination by taking account only of a destination address.

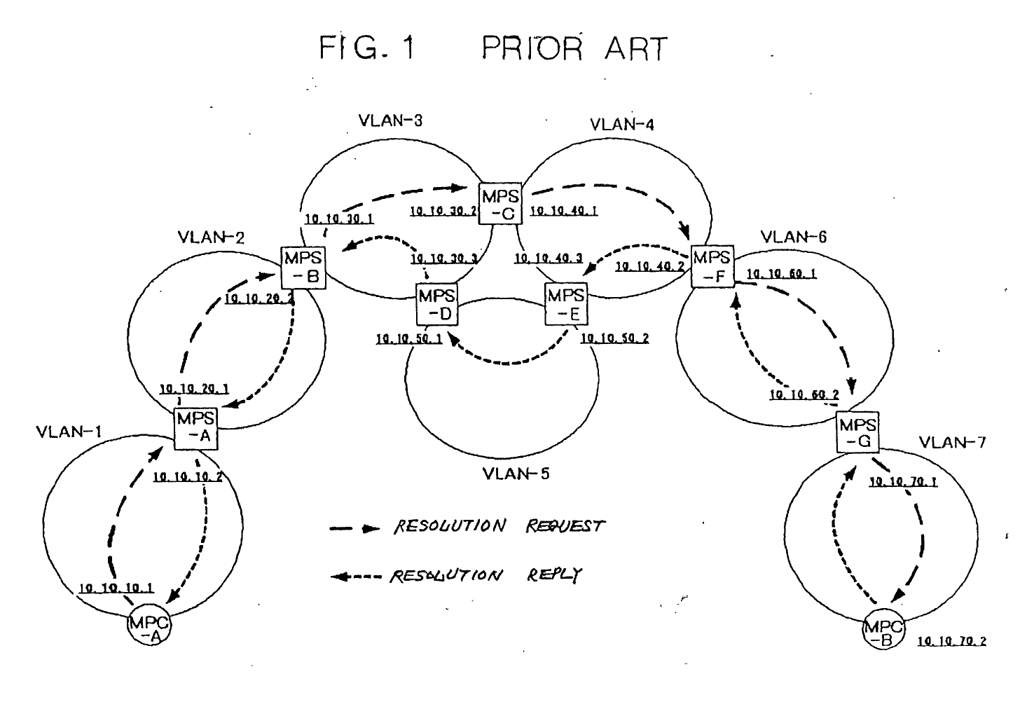

Reference will be made to FIG. 1 for describing the operation of the conventional MPOA system. While a layer 3 protocol is implemented by IP (Internet Protocol) in the following description, it may, of course, be implemented by IPX (Internet Packet Exchange) or or similar layer 3 protocol. FIG. 1 shows the flow of address resolution using a MPOA protocol and 10.10.0.0/24 networks, which are connected together and implemented by ATM networks. Assume that MPOA clients MPC-A and MPC-B belonging to VLAN-1 and VLAN-7, respectively, are capable of resolving an address by using the MPOA protocol.

Briefly, the conventional MPOA system allows data to be transferred between MPOA clients (MPC) by using Shortcut VC (Virtual Connection). An MPOA client sends an MPOA Resolution Request to an MPOA server (MPS). In response, the MPOA server transfers the Resolution Request to an adequate MPOA server to thereby effect address resolution. It is to be noted that each MPOA server serves as a Next Hop server (NHS) at the same time because address resolution between MPOA servers uses the NHRP protocol. The MPOA server received the Resolution Request searches a layer 3 routing table in order to find an adequate MPOA server to which the request should be transferred. For this purpose, the MPOA server is mounted on a router.

Address resolution will be described specifically with reference to FIG. 1. First, the MPOA client MPC-A sends to an MPOA server MPS-A an MPOA Resolution Request meant for a 10.10.70.2 network in order to communicate with the MPOA client MPC-B. In response, the MPOA server MPS-A constructs a NHRP Resolution Request in the form of a packet meant for the 10.10.70.2 network and sends it to an MPOA server MPS-B, which is the next hop. Referencing an IP routing table, the MPOA server MPS-B transfers the NHRP Resolution Request to an MPOA server MPS-C, which is the next hop. Subsequently, the NHRP Resolution Request is sequentially transferred from the MPOA server MPS-C to an MPOA server MPS-G via an MPOA server MPS-F.

The MPOA server MPS-G locates the MPOA client MPC-B for which the address resolution is meant by referencing an IP routing table and ARP (Address Resolution Protocol) information as well as ARP information for LAN emulation. The MPOA server MPS-G then sends an MPOA Cache Imposition Request to the MPOA client MPG-B. The MPOA client MPC-B received the MPOA Cache Imposition Request makes preparation for setting up a Shortcut VC and then sends an MPOA Cache Imposition Replay to the MPOA server MPS-G.

On receiving the MPOA Cache Imposition Replay from the MPOA client MPC-B. the MPOA server MPS-G constructs an NHRP Resolution Replay in the form of a packet meant for the MOPA server MPS-A, which has originated the NHRP Resolution Request. The MPOA server MPS-G searches for the MPOA server MPS-F, which is the next hop, by referencing the IP routing table and then sends the NHRP Resolution Reply to the MPOA server MPS-F. Subsequently, the NHRP Resolution Replay is sequentially sent from the MPOA server MPS-F to the MPOA server MPS-B via MPOA servers MPS-E and MPS-D.

The MPOA server MPS-A receives the NHRP Resolution Reply from the MPOA server MPS-B. The MPOA sever MPS-A then generates an MPOA Resolution Reply based on the NHRP Resolution Reply and sends it to the MPOA client MPC-A. The MPOA client MPC-A produces the ATM address of the MPOA client MPC-B and then sets up Shortcut VC toward the MPOA client MPC-B. Thereafter, the MPOA client MPG-A sends the IP data addressed for the 10.10.20.2 network over the shortcut VC.

In the specific procedure described with reference to FIG. 1, the MPOA server MPS-A received the MPOA Resolution Request from the MPOA client MPC-A is an Ingress MPS. The MPOA server MPS-G sent the MPOA Cache Imposition Request to the MPOA client MPC-B is an Egress MPS. The other MPOA servers are Transit NHSs.

The conventional MPOA system described above has some problems left unsolved, as stated earlier.

Briefly, the present invention is capable of determining, by using an NHRP packet, whether or not a desired destination is reachable. Specifically, the present invention is capable of detecting the Next Hop server (NHS) with the NHRP packet in the same manner as a traceroute command used in IP for detecting routers present on a data transfer route. Further, the present invention is capable of detecting MPOA servers (MPS) each constituting an MPOA system.

Moreover, the present invention detects an NHS and an MPS by using a Responder Address Extension, an NHRP Forward NHS Transit Record Extension and an NHRP Reverse Transit NHS Record Extension defined in RFC 2332. In addition, the present invention can detect a transit NHS or the last MPS by sending an NHRP Resolution Request to which the above three different Extensions are added to a destination IP address.

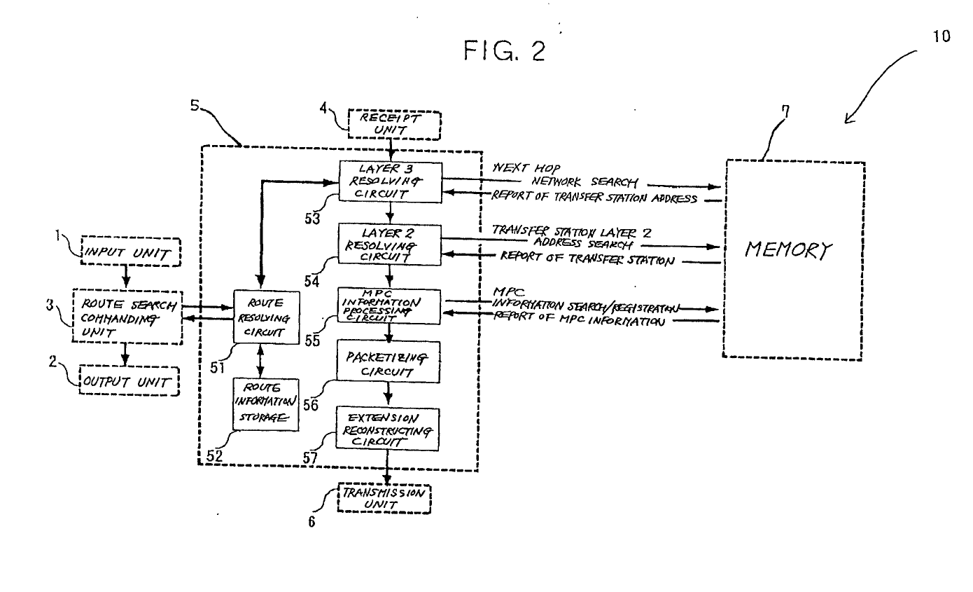

Referring to FIG. 2, an NHRP/MPOA system embodying the present invention will be described. As shown, the NHRP/MPOA system, generally 10, is generally made up of an input unit 1, an output unit 2, a route search commanding unit 3, a receipt unit 4, a packet handling unit 5, a transmission unit 6, and a memory 7. The packet handling unit 5 includes a route resolving circuit 51, a route information storage 52, a layer 3 resolving circuit 53, a layer 2 revolving circuit 54, an MPG information processing circuit 55, a packetizing circuit 56, and an Extension reconstructing circuit 57.

The input unit 1 is implemented as, e.g., a keyboard while the output unit 2 is implemented as, e.g., a display or a printer. The route search commanding unit 3 analyzes a command received from the input unit 1 or produces an address from a received packet. The receipt unit 4 receives a resolution request from another MPS or another MFC. The packet handling unit 5 analyzes the contents of received packets and execute necessary processing. The transmission unit 6 sends a resolution request to another MPS or another MPC. The memory 7 stores a routing table on a router, network interface information and other route information to be referenced at the time of data transfer. The memory 7 additionally stores information on the router on which the MPS is mounted. However, the memory 7 is not essential with the illustrative embodiment.

In the packet handling unit 5, the route resolving circuit 51 receives a command from the route search commanding circuit 3 or delivers the result of address resolution to the circuit 3. The route information storage 52 stores information relating to a resolution request, which the route resolving circuit 51 has sent for the display of a route. The layer 3 resolving circuit 53 determines, based on a layer 3 routing table stored in the memory 7, a layer 3 address to which a received packet should be transferred. The layer 2 resolving circuit 54 determines, based on correspondence between layer 3 addresses and layer 2 addresses stored in the memory 7, the layer 2 address of a terminal or that of a router to which a resolution request should be transferred.

The MPC information processing circuit 55 writes in the memory 7 information relating to an Ingress MPC sent an MPOA Resolution Request to the system 10 or information relating to an Egress MPC sent an MPOA Cache Imposition Request. Further, the processing circuit 55 searches information stored in the memory 7. The packetizing circuit 56 reconstructs received packets into packets to be sent by referencing layer-by-layer address information determined by the MPG information processing circuit 55, layer 3 resolving circuit 53 and layer 2 resolving circuit 54 as well as network interface information stored in the memory 7. The Extension reconstructing circuit 57 adds Extensions or scans an Extension list for adding the layer 3 address of the router to the list.

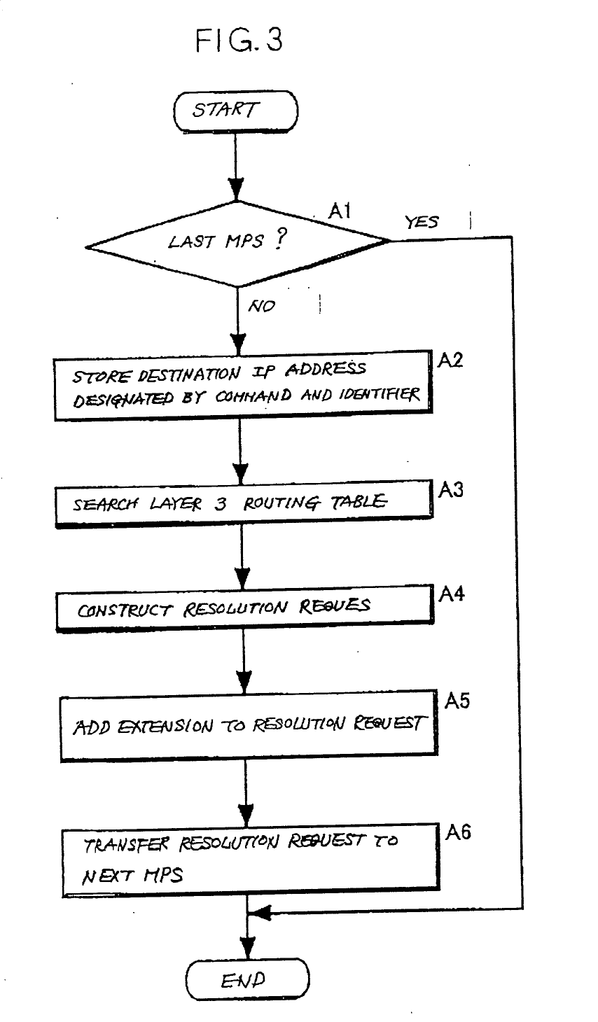

Reference will be made to FIGS. 3 through 5 for describing a specific route display procedure unique to the NHRP/MPOA system 10. First, the route search commanding circuit 3 delivers a destination IP address input from the input unit 1 to the route resolving circuit 51. In response, the route resolving circuit 51 calculates an identifier to be added to a resolution request. For example, a resolution reply can be identified if a Request ID is unconditionally assigned to route display.

As shown in FIG. 3, the route resolving circuit 51 determines whether or not the MPS is the last MPS (step A1). If the MPS is not the last MPS (NO, step A1), then the route resolving circuit 51 writes the destination IP address designated by the command and the identifier in the route information storage 52 (step A2). If the MPS is the last MPS (YES, step A1), then the route resolving circuit 51 informs the route search commanding circuit 3 of the absence of a transfer station because address resolution is not necessary. When transfer is not to be effected, it is necessary to determine the layer 2 address of the router on which the transferring MPS is mounted. It is to be noted that the last MPS refers to an MPS expected to execute processing including address resolution without transferring a received packet to another MPS.

After the step A2, the route resolving circuit 51 delivers the destination IP address and identifier to the layer 3 resolving circuit 53. In response, the layer 3 resolving circuit 53 searches the layer 3 routing table stored in the memory 7 by using the destination IP address as a key, thereby finding the address of the next hop or router and a network interface to which the packet should be sent (step A3). The layer 3 resolving circuit 53 then delivers the destination IP address, identifier and the layer 3 address of the next hop to the layer 2 resolving circuit 54. The layer 2 resolving circuit 54 searches the memory 7 in order to find a layer 2 address corresponding the above layer 3 address. The layer 2 resolving circuit 54 then informs the MPG information processing circuit 55 of the destination IP address, identifier, next hop IP address and layer 2 address corresponding thereto. At this stage of operation, MPG information to be written to the memory 7 does not exist. The MPC information processing circuit 55 therefore delivers the whole information received to the packetizing circuit 56.

The packetizing circuit 56 generates a resolution request in the form of a packet based on the information received from the MPG information processing circuit 55 (step A4). The Extension reconstructing circuit 57 adds a Responder Address Extension, an NHRP Forward Transit NHS Record Extension and an NHRP Reverse Transit NHS Record Extension to the resolution request (step A5). The resolution request with the three different Extensions is transferred to the next MPS via the transmission unit 6 (step A6).

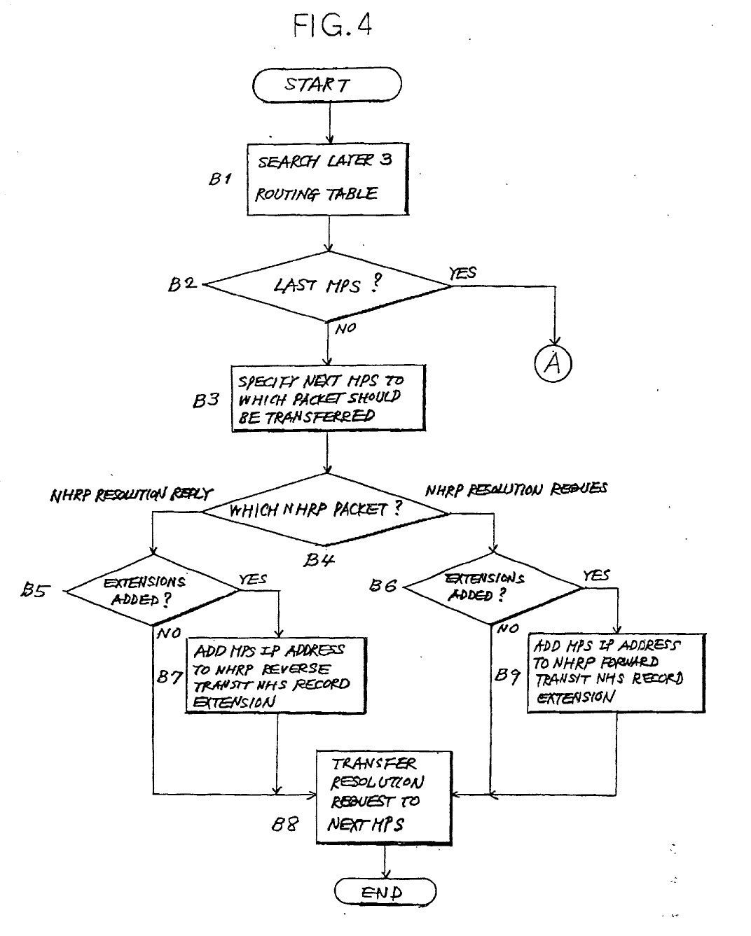

As shown in FIG. 4, assume that the receipt unit 4 receives a resolution request or a resolution reply implemented as a packet. Then, the receipt unit 4 delivers the received packet to the layer 3 resolving circuit 53. The layer 3 resolving circuit 53 searches the memory 7 by using the layer 3 routing table as a key in order to find the address of the next hop router and a network interface for which the packet is meant (step B1). At this instant, whether or not the searching MPS is the last MPS is determined (step B2).

If the searching MPS is not the last MPS (NO, step B2), then the following processing is executed in order to specify the next MPS to which the resolution request or the resolution reply should be transferred (step B3). The layer 3 resolving circuit 53 reports a destination IP address and a next hop IP address to the layer 2 resolving circuit 54. The layer 2 resolving circuit 54 searches for a layer 2 address corresponding to the next hop layer 3 address. The layer 2 resolving circuit 54 then delivers the destination IP address, next hop IP address, layer 2 address corresponding thereto and received packet to the MPC information processing circuit 55. At this instant, the MPC information processing circuit 55 searches the memory 7 in order to find MPC information and delivers, if MPC information is present, it to the packetizing circuit 56 together with the information received from the layer 2 resolving circuit 54. Further, the packetizing circuit 56 delivers the received packet to the Extension reconstructing circuit 57.

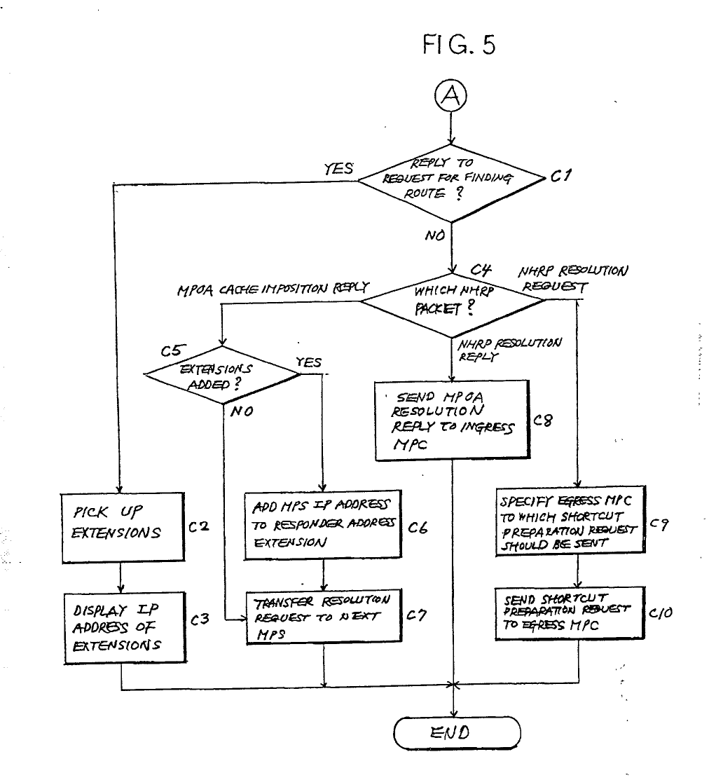

If the searching MPS is the last MPS (YES, step B2), then the step B2 is transferred to processing A to be described later with reference to FIG. 5.

After the step B3, the extension reconstructing circuit 57 determines the kind of the NHRP packet received (step B4). Assume that the received packet is an NHRP Resolution Reply, i.e., the MPS is a Transit MPS. Then, the Extension reconstructing circuit 57 determines whether or not an NHRP Reverse Transit NHS Record Extension is added to the NHRP Resolution Replay (step B5). If the answer of the step B5 is NO, then the Extension reconstructing circuit 57 transfers the Replay to the next MPS via the transmission unit 6 (step B8). If the answer of the step B5 is YES, meaning that an NHRP Reverse transit NHS Record Extension is added to the Reply, then the Extension reconstructing circuit 57 adds the address of the MPS to the above extension (step 87). At this instant, the circuit 57 adds the IP address of the router on which the MPS is mounted to the NHRP Reverse Transit NHS Record Extension.

On the other hand, assume that the received packet identified in the step B4 is an NHRP Resolution Request, i.e., the MPS is a Transit MPS. Then, the Extension reconstructing circuit 57 determines whether or not an NHRP Forward Transit NHS Record Extension is added to the packet (step B6). If the answer of the step B6 is NO, the Extension reconstructing circuit 57 transfers the packet to the next MPS via the transmission unit 6 (step B8). If otherwise (YES, step B6), then the extension reconstructing circuit 57 adds the IP address of the MPS to the NHRP Forward Transit NHS Record Extension (step B9). In addition, the circuit 57 adds the IP address of the router on which the MPS is mounted to the above Extension. Subsequently, the circuit 57 sends the NHRP Resolution Request or the NHRP Resolution Reply to the next MPS.

Referring to FIG. 5, processing to be executed when the MPS is the last MPS (YES, step B2, FIG. 4) will be described hereinafter. As shown, the route resolving circuit 51 determines whether or not the received packet is a reply to a resolution request (step C1). Specifically, the layer 3 resolving circuit 53 inquires the route resolving circuit 51 of the identifier of an NHRP Resolution Reply. In response, the route resolving circuit 51 compares the inquired identifier with the identifier stored in the route information storage 52. If the two identifiers compare equal, then the route resolving circuit 51 determines that the packet is a reply to a resolution request.

If the packet is a reply to a resolution request (YES, step C1), then the route resolving circuit 51 commands the layer 3 resolving circuit 53 to inform the circuit 51 of the contents of the Extensions. In response, the layer 3 resolving circuit 53 picks up three Extensions contained in the reply and reports the contents of the Extensions to the route resolving circuit 51 (step C2). Subsequently, the route resolving circuit 51 reports the contents of the Extensions to the route search commanding unit 3. The route search commanding unit 3 rearranges the IP addresses of the Extensions and then delivers them to the output unit 2. Consequently, the output unit 2 displays the IP addresses of the Extensions on its screen (step C3).

On the other hand, if the two identifiers are not identical, then the route resolving circuit 51 determines that the packet is not a reply to a resolution request (NO, step C1). In this case, the layer 3 resolving circuit 53, layer 2 resolving circuit 54 and MPC information processing circuit 55 determine the kind of the received NHRP packet (step C4). If the packet determined in the step C4 is an MPOA Cache Imposition Reply, then the MPC information processing circuit 55 searches Egress MPC information stored in the memory 7 to see if a Responder Address Extension is added to a Resolution Request derived the Reply (step C5). The processing circuit 55 delivers the result of this decision to the packetizing circuit 56.

If a Responder Address Extension is not added to the above-mentioned Resolution Request (NO, step C5), then the packetizing circuit 56 sends a NHRP Resolution Reply to the next MPS via the transmission unit 6 (step C7). If a Responder Address Extension is added to the Resolution Request (YES, step C5), then the packetizing circuit 56 adds the IP packet of the MPS to the Extension (step C6). At this instant, the Extension reconstructing circuit 57 adds the IP address of the router on which the MPS is mounted to the Responder Address Extension. Subsequently, the Extension reconstructing circuit 57 sends a Resolution Request to the next MPS (step C7). At this time, the circuit 57 reconstructs a Responder Address Extension and then feeds the added NHRP Resolution Reply to the transmission unit 6.

If the packet identified in the step C4 is an NHRP Resolution Request, then the results of processing executed by the layer 3 resolving circuit 53 and layer 2 resolving circuit 54 show the presence of an Egress MPC. In this case, an egress MPC to which a Shortcut preparation request is to be sent is specified (step C9). At this instant, the MPC information processing circuit 55 writes Egress MPG information and information relating to the Extensions attached to the Resolution Request in the memory 7.

Subsequently, the Shortcut preparation request is sent to the Egress MPG specified in the step C9 (step C10). More specifically, the packetizing circuit 56 generates an MPOA cache Imposition Request and sends it to the Egress MPC via the transmission unit 6.

As stated above, when a network is in an MPOA environment, the illustrative embodiment allows route information to be examined by use of the MPOA protocol and therefore allows a route to be found independently of actual data communication. In addition, the illustrative embodiment allows a faulty portion to be located independently of actual data communication.

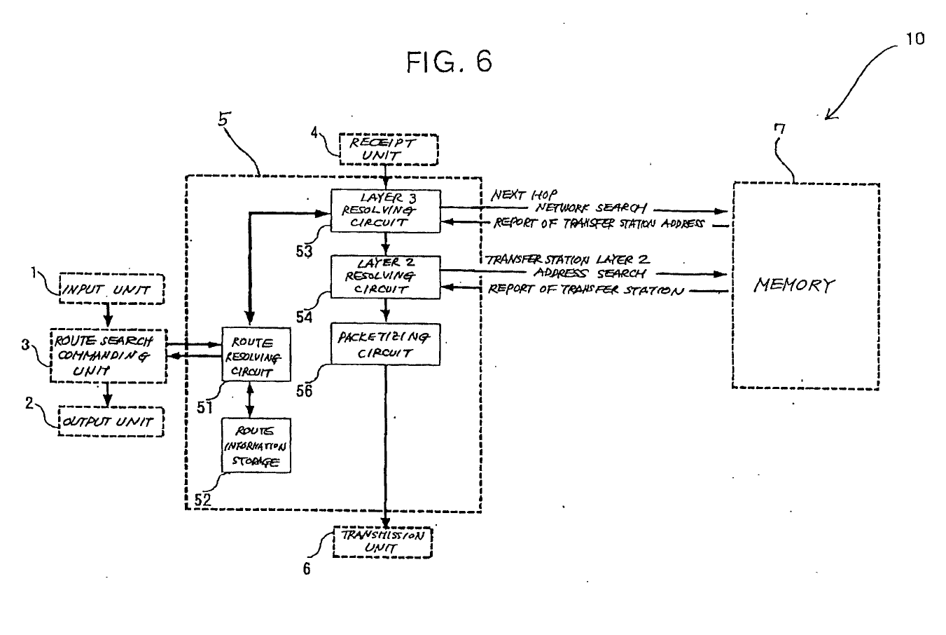

An alternative embodiment of the present invention will be described with reference to FIG. 6. In FIG. 6, identical structural elements as the structural elements shown in FIG. 2 are designated by identical reference numerals and will not be described specifically in order to avoid redundancy. While the previous embodiment is applied to an MPS, this embodiment is applied to an MPC. In the case of an MPC, the three Extensions described above are added to an MPOA Resolution Request while the contents of the extensions added to an MPOA Resolution Reply are examined.

The previous embodiment examines route information by using the Extensions defined in RFC 2332. By contrast, the illustrative embodiment uses the Hop Count of an NHRP packet. Further, the illustrative embodiment executes processing in the same manner as in the case of a traceroute command using the TTL (Time-To-Live) of an IP packet. As for the Hop Count of an NHRP packet, an NHS received an NHRP packet decrements the count by one when it transfers the packet to another NHS. An NHS found that the Hop Count is zero discards the NHRP packet. In addition, to locate a faulty portion, a NHRP Error Indication is sent to an NHS that has sent the NHRP packet. This allows the transfer route of a resolution request to be examined.

Specifically, the NHRP/MPOA system 10 shown in FIG. 6 differs from the NHRP/MPOA system shown in FIG. 3 in that the Extension reconstructing circuit 57 is absent. In the illustrative embodiment, the route resolving circuit 51 manages a destination IP address and a hop count. The route information storage 52 stores the destination IP address, identifier and hop count being managed by the route resolving circuit 51. The layer 3 resolving circuit 53 analyzes the content of an NHRP Error Indication to thereby pick up a source address and reports the source address to the route resolving circuit 51.

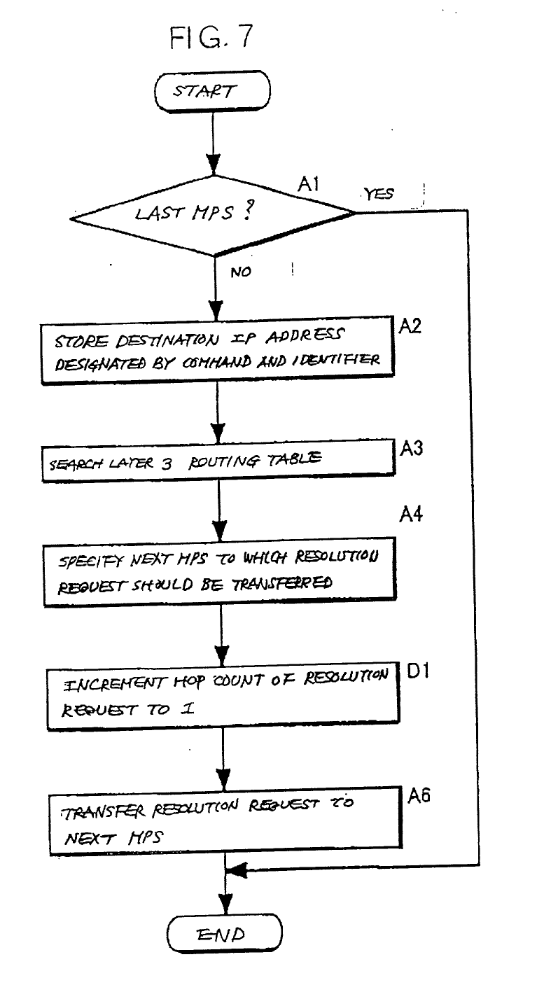

FIG. 7 demonstrates a specific procedure to be executed by the illustrative embodiment in response to a route display command, which is input by the user. As shown, steps A1 through A4 are identical with the steps A1 through A4 shown in FIG. 3. In the event of address resolution, the route resolving circuit 51 writes a hop count in the route information storage 52. The hop count stored in the storage 52 is “1” at first and is sequentially incremented by 1 (one) every time a Resolution Request meant for the same destination is sent.

As shown in FIG. 7, after the next MPS has been specified (step A4), the packetizing circuit 56 increments the hop count of the Resolution Request to “1” (step D1). Subsequently, the packetizing circuit 56 sends the Resolution Request to the next MPS via the transmission unit 6 (step A6). The next MPS received the Resolution Request executes receipt processing if a hop count included in the Request is an integer. The MPS then transfers the packet and sends a Shortcut preparation request to the Egress MPC. At the time of transfer, the MPS decrements the hop-count of the packet by 1. If the hop count of the received packet is “0”, then the MPS generates a NHRP Error Indication packet and sends it to the source address, as defined in RFC 2332.

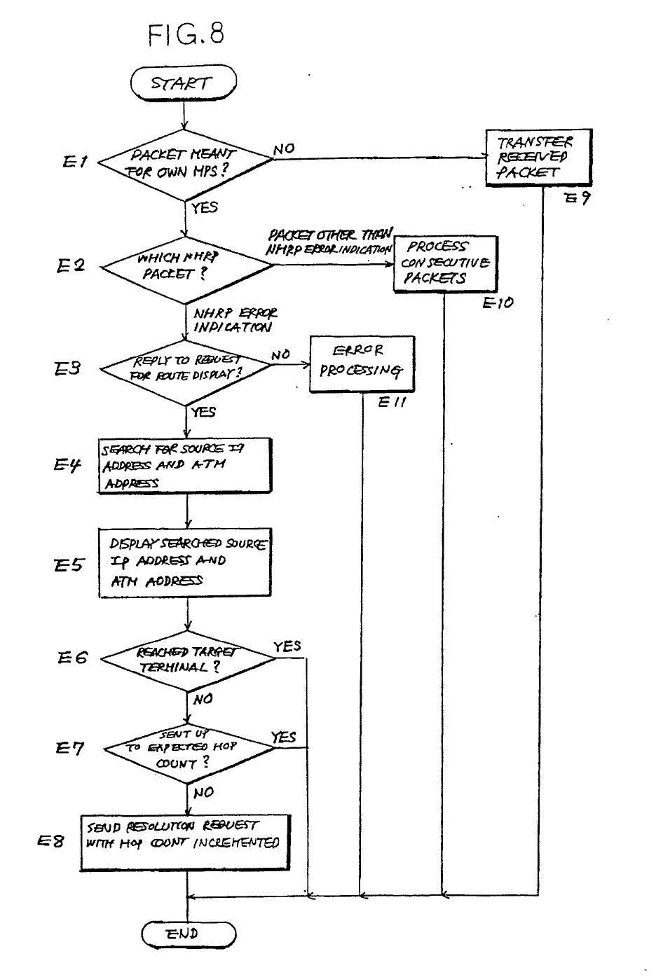

As shown in FIG. 8, assume that the MPS sent a Resolution Request has received an NHRP Error Indication. Then, the route resolving circuit 51 determines whether or not the received packet is meant for the MPS to which the circuit 51 belongs (step E1). More specifically, the route resolving circuit 51 determines whether or not the source address is identical with the IP address of the router on which the MPS is mounted. If the answer of the step E1 is NO, then processing for transferring the received packet is executed (step E9). If the answer of the step E1 is YES, then the layer 3 resolving circuit 53 determines the kind of the received packet (step E2). If the received packet is an NHRP packet other than a NHRP Error Indication packet, then processing for receiving consecutive packets is executed (step E10).

If the received packet is an NHRP Error Indication packet, as determined in the step E2, then the route resolving circuit 51 determines whether or not the NHRP Error Indication packet is a reply to the Resolution Request sent (step E3). Specifically, because the NHRP error indication packet contains an error packet, the route resolving circuit 51 can determine whether or the identifier attached to the error packet is identical with the identifier attached to the Resolution Request packet. More specifically, the layer 3 revolving circuit 53 picks up the identifier of the error packet and reports it to the route resolving circuit 51. If the identifier of the error packet is identical with the identifier stored in the route information storage 52, then the route resolving circuit 51 determines that the NHRP Error Indication is a reply to the Resolution Request (YES, step E3). The route resolving circuit 51 then commands the layer 3 resolving circuit 53 to inform it of a source IP address and an ATM address. If the answer of the step E3 is NO, error processing is executed.

If the answer of the step E3 is YES, then the layer 3 resolving circuit 53 picks up a source IP address and an ATM address out of the received NHRP Error Indication and delivers them to the route resolving circuit 51 (step E4). The source IP address and ATM address are representative of an MPS that received the Resolution Request. The route resolving circuit 51 delivers the source IP address and ATM address to the route search commanding circuit 3 that, in turn, transfers them to the output unit 2. The output unit 2 displays the source IP address and ATM address on its screen (step E5).

Further, the route resolving circuit 51 determines whether or not the source IP address of the received NHRP Error Indication is identical with the IP address of the target terminal stored in the memory 7, thereby determining whether or not the Resolution Request has reached the target terminal (step E6). Specifically, if the source IP address is identical with the IP address stored in the route information storage 52, the route resolving circuit 51 determines that the Resolution Request has reached the target terminal (YES, step E6). In this case, the procedure ends without sending any other Resolution Request.

If the answer of the step E6 is NO, meaning that the Resolution Request has not reached the target terminal, then the route resolving circuit 51 determined whether or not the Request has been repeatedly sent up to the expected hop count stored in the route information storage 52 (step E7). If the answer of the step E7 is YES, then the procedure ends. If the answer of the step E7 is NO, then the route resolving circuit 51 commands the layer 3 resolving circuit 53 to send a Resolution Request with a hop count incremented by 1 via the transmission unit 6 (step E8). The route resolving circuit 51 writes the hop count incremented by 1 in the route information storage 52.

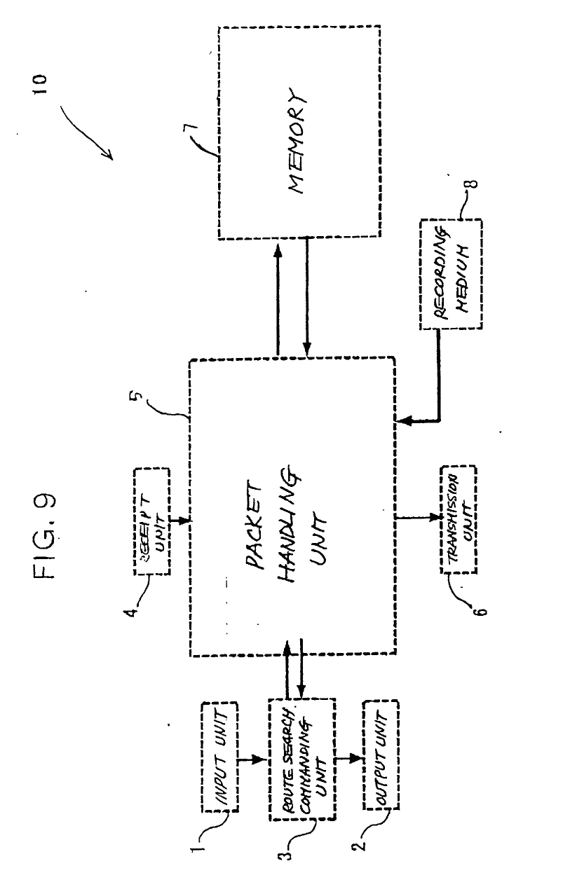

Another alternative embodiment of the present invention will be described with reference to FIG. 9. In FIG. 9, structural elements identical with the structural elements shown in 2 or 6 are designated by identical reference numerals and will not be described in order to avoid redundancy. As shown, the NHRP/MPOA system 10 additionally includes a magnetic disk, semiconductor memory or similar recording medium 8 storing a route display program. The packet handling unit 5 fetches the program stored in the recording medium 8 and operates under the control of the program. The packet handing unit 5 is identical in configuration and operation with the packet handling unit 5 shown in FIG. 2 or 6.

In operation, when the address of a destination a route to which should be found is input on the input unit 1, the route search commanding unit 3 delivers the IP address of the destination to the packet handling unit 5. In response, the packet handling unit 5 generates a Resolution Request based on the NHRP protocol. By referencing the routing table and network interface information stored in the memory 7, the packet handling unit 5 selects a station to which the Resolution Request should be transferred. The transmission unit 6 sends the Resolution Request to the above station.

When the receipt unit 4 receives a Resolution Reply as a reply to the Resolution Request, the packet handling unit 5 picks up a source address out of the Reply and delivers it to the route search commanding unit 3. Consequently, the source address appears on the screen of the output unit 2 as a result of analysis.

Referring again to FIG. 1, differences between the system of the present invention and the conventional system will be described. It is impossible with the conventional MPOA system to determine how a Resolution Request will be transferred over a network without examining the IP routing table of the router or collecting data flowing on the network, as discussed earlier.

On the other hand, by using NHRP Extensions, the system of the present invention automatically collects and displays the IP addresses of MPOA servers via which a Resolution Request is transferred. More specifically, each MPOA server MPS deals with the Extensions in different ways in accordance with the kind of a received NHRP packet. Further, the MPOA server MPS-A adds the three different extensions, e.g., Responder Address Extension, NHRP Forward NHS Transit Record Extension and NHRP Reverse Transit NHS Record Extension to a Resolution Request.

The MPOA server MPS-B, which is a transit MPOA server MPS, adds the IP address of the router to the NHRP Forward Transit NHS Record Extension of the received Resolution Request. This is also true with the MPOA servers MPS-C and MPC-F. The MPOA server MPS-D, which is another transit MPOA server MPS, adds the IP address of the router to the NHRP Forward Transit NHS Extension of a received NHRP Resolution Reply. The MPOA server MPS-E operates in the same manner as the MOPA server MPS-D. The MPOA server MPS-G, which is an Egress MPOA server MPS, adds the IF address of the router to the NHRP Responder Address Extension of a NHRP Resolution Reply to send.

In summary, in accordance with the present invention, when a network is in an MPOA environment, route information is examined by use of the MPOA protocol, so that a route can be found independently of actual data communication. In addition, a faulty portion can be located independently of actual data communication.

Various modifications will become possible for those skilled in the art after receiving the teachings of the present disclosure without departing from the scope thereof.

What is claimed is:

1. In an NHRP/MPOA (Next Hop Resolution Protocol/Multi-Protocol Over ATM Asynchronous Transfer Mod)) system, there is provided means for tracing route resolution by using Extensions of an NHRP protocol defined in RFC 2332.

2. The NHRP/MPOA system as claimed in claim 1, wherein there is further provided a MPOA client that traces route resolution by using an MPOA packet.

3. The NHRP/MPOA system as claimed in claim 2, wherein there is further provided an MPOA server that traces route resolution by using an MPOA packet.

4. The NHRP/MPOA system as claimed in claim 3, wherein there is further provided means for determining, by using the NHRP packet, whether or not a particular destination is reachable.

5. The NHRP/MPOA system as claimed in claim 4, wherein there is further provided means for detecting, in the same manner as a traceroute command particular to an IP (Internet Protocol) for detecting routers present on a data transfer route, a Next Hop server present on a data transfer route on the basis of the NHRP packet, and detecting said MPOA server that supervises MPOA data transfer.

6. The NHRP/MPOA system as claimed in claim 5, wherein the Extensions comprise three extensions, i.e., a Responder Address Extension, an NHRP Forward NHS Transit Record Extension and an NHRP Reverse Transit NHS Record Extension defined in RFC 2332, said means detecting said Next Hop server and said MPOA server by using said three Extensions.

7. The NHRP/MPOA system as claimed in claim 5, wherein there is further provided means for detecting the Next Hop server or a last MPOA server by sending to a destination IP address an NHRP Resolution Request to which a Responder Address Extension, an NHRP Forward NHS Transit Record Extension and an NHRP Reverse NHS Transit Record Extension are added.

8. The NHRP/MPOA system as claimed in claim 7, wherein there are further provided:
an input unit serving as data inputting means;
an output unit comprising a display or a printer;
a route search commanding unit for analyzing a command received from said input unit or producing an address from a received packet;
a receipt unit for receiving a Resolution Request from the MPOA client;
a packet handling unit for analyzing a content of a received packet and executing necessary processing; and
a transmission unit for sending a Resolution Request to the MPOA client.

9. The NHRP/MPOA system as claimed in claim 8, wherein there is further provided a memory storing a routing table on the router, network interface information, and router information on which the MPOA server is mounted.

10. The NHRP/MPOA system as claimed in claim 9, wherein said packet handling unit comprises:
a route resolving circuit for receiving a command from said route search commanding unit or delivering a result of address resolution to said route search commanding unit;
a route information storage for storing information relating to the Resolution Request, which said route resolving circuit has sent for displaying a route;
a layer 3 resolving circuit for determining, based on a layer 3 routing table of the router stored in said memory, a layer 3 address to which a received packet should be transferred;
a layer 2 resolving circuit for determining, based on information indicative of correspondence between layer 3 addresses and layer 2 addresses stored in said memory, a terminal to which the Resolution Request should be transferred or a layer 2 address of the router;
an MPC information processing circuit for writing in said memory information relating to at least one of an Ingress MPG from which an MPOA Resolution Request is received and an Egress MPC that has sent an MPOA Cache Imposition Request, and searching for said information stored;
a packetizing circuit for reconstructing, based on layer-by-layer address information determined by said MPC information processing circuit, said layer 3 resolving circuit and said layer 2 resolving circuit, and the network interface information stored in said memory, a received packet to thereby produce a packet to be sent; and
an Extension reconstructing circuit for adding the Extensions or examining an Extension list to thereby add the layer 3 address of the router to said Extension list.

11. In an NHRP/MPOA system, there is provided means for tracing route resolution by using a Hop Count of an NHRP protocol defined in RFC 2332.

12. The NHRP/MPOA system as claimed in claim 11, wherein there is further provided a MPOA client that traces route resolution by using an MPOA packet.

13. The NHRP/MPOA system as claimed in claim 12, wherein there is further provided an MPOA server that traces route resolution by using an MPOA packet.

14. The NHRP/MPOA system as claimed in claim 13, wherein there is further provided means for determining, by using the NHRP packet, whether or not a particular destination is reachable.

15. The NHRP/MPOA system as claimed in claim 14, wherein there is further provided means for detecting, in the same manner as a traceroute command particular to an IP (Internet Protocol) for detecting routers present on a data transfer route, a Next Hop server present on a data transfer route on the basis of the NHRP packet, and detecting said MPOA server that supervises MPOA data transfer.

16. The NHRP/MPOA system as claimed in claim 15, wherein the Extensions comprise three extensions, i.e., a Responder Address Extension, an NHRP Forward NHS Transit Record Extension and an NHRP Reverse Transit NHS Record Extension defined in RFC 2332, said means detecting said Next Hop server and said MPOA server by using said three Extensions.

17. The NHRP/MPOA system as claimed in claim 15, wherein there is further provided means for detecting the Next Hop server or a last MPOA server by sending to a destination IP address an NHRP Resolution Request to which a Responder Address Extension, an NHRP Forward NHS Transit Record Extension and an NHRP Reverse NHS Transit Record Extension are added.

18. The NHRP/MPOA system as claimed in claim 17, wherein there are further provided:
an input unit serving as data inputting means;
an output unit comprising a display or a printer;
a route search commanding unit for analyzing a command received from said input unit or producing an address from a received packet;
a receipt unit for receiving a Resolution Request from the MPOA client;
a packet handling unit for analyzing a content of a received packet and executing necessary processing; and
a transmission unit for sending a Resolution Request to the MPOA client.

19. The NHRP/MPOA system as claimed in claim 18, wherein there is further provided a memory storing a routing table on the router, network interface information, and router information on which the MPOA server is mounted.

20. The NHRP/MPOA system as claimed in claim 19, wherein said packet handing unit comprises:
a route resolving circuit for receiving a command from said route search commanding unit or delivering a result of address resolution to said route search commanding unit;
a route information storage for storing information relating to the Resolution Request, which said route resolving circuit has sent for displaying a route;
a layer 3 resolving circuit for determining, based on a layer 3 routing table of the router stored in said memory, a layer 3 address to which a received packet should be transferred;
a layer 2 resolving circuit for determining, based on information indicative of correspondence between layer 3 addresses and layer 2 addresses stored in said memory, a terminal to which the Resolution Request should be transferred or a layer 2 address of the router;
an MPC information processing circuit for writing in said memory information relating to at least one of an Ingress MPC from which an MPOA Resolution Request is received and an Egress MPC that has sent an MPOA Cache Imposition Request, and searching for said information stored;
a packetizing circuit for reconstructing, based on layer-by-layer address information determined by said MPC information processing circuit, said layer 3 resolving circuit and said layer 2 resolving circuit and the network interface information stored in said memory, a received packet to thereby produce a packet to be sent; and
an Extension reconstructing circuit for adding the Extensions or examining an Extension list to thereby add the layer 3 address of the router to said Extension list.

21. In a route displaying method, Extensions of a NHRP protocol defined in RFC 2332 are used to trace route resolution.

22. The method as claimed in claim 21, wherein an NHRP packet is used to determine whether not a particular destination is reacheable.

23. The method as claimed in claim 22, wherein a next Hop server present on a data transfer route is detected on the basis of the NHRP packet in the same manner as a traceroute command particular to an IP for detecting routers present on a data transfer route, and the MPOA server that supervises MPOA data transfer is detected.

24. The method as claimed in claim 23, wherein the Next Hop server and the MPOA server are detected by using a Responder Address Extension, an NHRP Forward NHS Transit Record Extension and an NHRP Reverse Transit NHS Record Extension defined in RFC 2332.

25. The method as claimed in claim 24, wherein at least one of the Next Hop server and a last MPOA server is detected by sending to the destination IP address an NHRP resolution request to which a Responder Address Extension, a NHRP Forward NHS Transit Record Extension and a NHRP Reverse NHS Transit Record Extension are added.

26. In a route displaying method, route resolution is traced by using a Hop Count of an NHRP protocol defined in RFC 2332.

27. The method as claimed in claim 26, wherein an NHRP packet is used to determine whether not a particular destination is reacheable.

28. The method as claimed in claim 27, wherein a next Hop server present on a data transfer route is detected on the basis of the NHRP packet in the same manner as a traceroute command particular to an IP for detecting routers present on a data transfer route, and the MPOA server that supervises MPOA data transfer is detected.

29. The method as claimed in claim 28, wherein the Next Hop server and the MPOA server are detected by using a Responder Address Extension, an NHRP Forward NHS Transit Record Extension and an NHRP Reverse Transit NHS Record Extension defined in RFC 2332.

30. The method as claimed in claim 29, wherein at least one of the Next Hop server and a last MPOA server is detected by sending to the destination IP address an NHRP resolution request to which a Responder Address Extension, a NHRP Forward NHS Transit Record Extension and a NHRP Reverse NHS Transit Record Extension are added.
